(19) United States
(12) Patent Application Publication
(10) Pub. No.: US 2025/0203466 A1
(43) Pub. Date: Jun. 19, 2025

(54) SYSTEMS AND METHODS FOR IMPLEMENTING COMMUNICATIONS HANDOVERS BETWEEN GROUND-BASED STATIONS IN AN AVIATION COMMUNICATIONS NETWORK

(71) Applicant: AURA Network Systems, Inc., McLean, VA (US)

(72) Inventors: Tamara Lynne CASEY, Annapolis, MD (US); Michael Robert GAGNE, Monrovia, MD (US); Vale TOLPEGIN, Keswick, VA (US); James O. NEEL, Lynchburg, VA (US)

(21) Appl. No.: 18/986,644

(22) Filed: Dec. 18, 2024

Related U.S. Application Data
(60) Provisional application No. 63/611,756, filed on Dec. 18, 2023.

(51) Int. Cl. H04W 36/00; G08G 5/32; H04W 12/037; H04W 12/041

(52) U.S. Cl. CPC H04W 36/0055; G08G 5/32; H04W 12/037; H04W 12/041

(57) ABSTRACT

Disclosed herein is a method for performing communication link handoffs between ground-based stations and aircraft in an aviation communications network. In the communications network, ground based stations interspersed throughout a coverage area of the network can be utilized to provide one or more aircraft flying within the coverage area with communications links that facilitate communication between an operator and an aircraft. In one or more examples, during the operation of the flight, the spectrum management system or other controller can coordinate the transfer of communications responsibilities between ground-stations of the network. The network can use a priori information from the flight plan to pre-coordinate handovers before the actual handover is to be initiated. In one or more examples, pre-coordination can include exchanging cryptographic keys between a source base station and a probable target base station of a handover.

### CROSS REFERENCE TO RELATED APPLICATIONS

This application claims the benefit of U.S. Provisional Application No. 63/611,756, filed Dec. 18, 2023, the content of which is herein incorporated by reference in its entirety for all purposes.

### FIELD

This disclosure relates to implementing communications handovers between ground-based assets or other communications assets in an aviation communications network, and more specifically, to systems and methods for utilizing flight plans and other flight information about the aircraft being handed over between communications assets to secure communications during a handover and to minimize the amount of time required to implement a communications handover.

### BACKGROUND

For both manned and unmanned flights, the data link between airborne assets and the ground control systems is a critical resource that needs to be maintained throughout a flight. Airborne assets may relay operationally critical communications and transmit necessary information to the ground control system, and the airborne assets may also receive necessary information from the control system. In the example of unmanned aerial vehicles (UAVs), UAV operators and their control systems, often based on the ground, must be in constant communication with the UAV not only to provide instructions to the UAV, but also to receive critical telemetry from the UAV that informs the control system and their operator about the UAV's operational status. The communications links between the aircraft and (ground) control systems can be especially critical when the UAV is operating beyond the line of sight of the operator since the operator may rely exclusively on the communications transmitted to and from the aircraft being piloted to effectively and safely control the aircraft since the operator may not have a direct radio link to an air traffic controller but instead must rely on a communications network to facilitate communications.

In order to implement an aviation communications network, the network may rely on multiple ground base stations that are located over a large geographic area so as to ensure that at least one of the base stations is within sufficient proximity to an aircraft flying in the network so that the aircraft can be provided with a reliable communications link to the ground and ultimately to the operator of the aircraft. In one or more examples, the network could rely on other types of base station elements including satellites (geosynchronous and low earth orbit), aerostats, etc, in addition to or in combination with ground-based elements. When an aircraft is transiting the coverage region of an aviation communications network, the aircraft may be passed from a first (source) base station of the network to another (target) base station of the network when the target base station is likely to provide a better communications link to aircraft than the first (source) base station. In order to maintain continuous communications between the airborne radio and a remote operator, the active communications link between the communications network and airborne radio must be transitioned between individual base stations to pass the responsibility for operating a reliable communications link between the aircraft and the ground.

In many respects, an aviation communications network, such as the one described above, can operate similarly to a mobile phone cellular network in which a mobile phone communicates with the cellular network through one or more base stations that are interspersed throughout the coverage area of the cellular network. Cellular networks (such as an LTE network) employ handover procedures between base stations that ensure that a mobile phone's communications are handed over from one base station to another while maintaining the integrity and security of the communications. However, in the context of an aviation communications network such handover procedures may not be suited to implement handovers between ground-based stations in the network. Often the security procedures used by cellular networks to handover communications between base stations can cause latency in communications that may be unacceptable in the aviation context. Such latency may increase the probability of aircraft control delays that would effectively degrade the operator's ability to maintain control of the aircraft. Thus, what is needed is a handover procedure that can minimize latency while also ensuring communications continuity.

### SUMMARY

According to an aspect of the disclosure, a communications network comprising a plurality of ground base stations interspersed throughout a coverage area of the network can be utilized to provide one or more aircraft flying within the coverage area with one or more communications links that facilitates communication between an operator and the aircraft even if the aircraft is operating beyond the visual line of sight of the operator. In one or more examples, the network itself (i.e., supported by internal systems such as a spectrum management system or other controller) can make decisions as to which ground-station any particular aircraft will use at any given time to communicate with a ground-based operator. In one or more examples, the network can decide which of the ground stations a particular flight will use at any given time prior to the commencement of the flight and based on the submitted flight plan. In one or more examples, the spectrum management system or other controller can calculate which base station of the aviation communications network will provide the best communications channel with the network to the aircraft radio at any given moment during the intended flight plan.

In one or more examples, during the operation of the flight, the spectrum management system or other controller can coordinate the transfer of communications responsibilities between ground-stations of the network. In other words, the network can coordinate handovers between ground-stations during the flight based not only on the flight plan but also the current position, radio metrics, and operating conditions of the flight. In one or more examples, and since the path of the flight can be either deterministic or at least predicted with high confidence, the network can use a priori information from the flight plan to pre-coordinate handovers before the actual handover is to be initiated. In one or more examples, pre-coordination can include exchanging cryptographic keys between a source base station and a probable target base station of a handover so as to securely transfer communications for a flight from the source base station to the target base station.

### BRIEF DESCRIPTION OF THE FIGURES

The invention will now be described, by way of example only, with reference to the accompanying drawings, in which:

FIG. 1 illustrates an aviation communications network according to examples of the disclosure.

FIG. 2 illustrates an exemplary system for RF spectrum management of aviation communication networks according to examples of the disclosure.

FIG. 3 illustrates an exemplary cellular network according to examples of the disclosure.

FIG. 4 illustrates an exemplary process for performing handovers in a cellular network according to examples of the disclosure.

FIG. 5 illustrates an exemplary process for performing handovers in an aviation network according to examples of the disclosure.

FIG. 6 illustrates an exemplary distributed ledger system according to examples of the disclosure.

FIG. 7 illustrates an exemplary aviation communication network with distributed ledger capabilities according to examples of the disclosure.

FIG. 8 illustrates an exemplary process for performing handovers in an aviation communications network with distributed ledger capabilities according to examples of the disclosure.

FIG. 9 illustrates an exemplary process for performing handovers in an aviation communications network with distributed ledger capabilities when a deviation in a flight plan occurs according to examples of the disclosure.

FIG. 10 illustrates an exemplary computing system, according to examples of the disclosure.

FIG. 11 illustrates an exemplary computing system, according to examples of the disclosure.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

### Aviation Communication Network

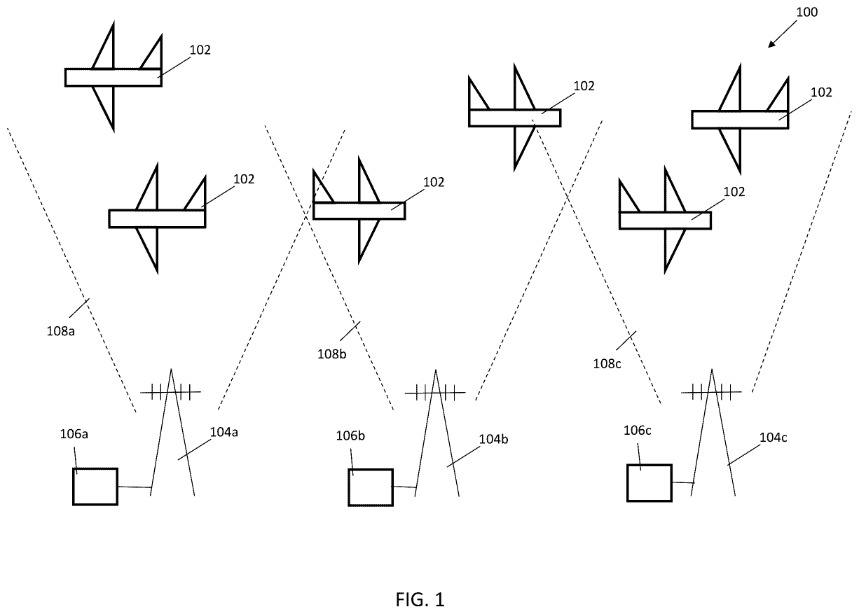

FIG. 1 illustrates an aviation network according to examples of the disclosure. The example of FIG. 1 illustrates an exemplary aviation communications network 100 that can be configured to provide communications between one or more (ground) base stations 104a-c and one or more aircraft 102 in-flight. Each of the base stations 104a-c include one or more antennas configured to transmit communications to and receive communications from the network to the one or more aircraft 102. In one or more examples, each base station 104a-c can be configured to provide transmissions within a coverage area 108a-c. For example, base station 104a can be configured to transmit radio frequency (RF) spectrum radio signals over geographic coverage area 108a. Base station 104b can be configured to transmit RF spectrum radio signals over geographic coverage area 108b, and base station 104c can be configured to transmit RF spectrum radio signals over geographic coverage area 108c. In one or more examples, geographic coverage areas 108a-c can be three-dimensional volumes that not only cover a certain range of latitude and longitude, but also provide coverage to areas from the ground up to a maximum serviceable altitude.

In one or more examples, each aircraft 102 can be handed over from one (ground) base station to the next during the duration of its flight. Additionally or alternatively, the methods disclosed herein can also facilitate handovers and/or rapid reattachment to redundant sites in the event of ground station failures. For instance, at the beginning of a flight, base station 104a can be responsible for providing a communications channel between an operator on the network and the aircraft while the aircraft 102 is within the coverage area 108a. If during the flight, the aircraft transits out of the coverage area 108a into coverage area 108b, then responsibility for providing the communications channel can transition from base station 104a to base station 104b. If during the flight, the aircraft 102 transits out of coverage area 108b into coverage area 108c, then responsibility for providing the communications channel can transition from base station 104b to base station 104c. In this way, the communications network 100 can be configured to ensure that an aircraft has an established communications channel with at least one base station at any point along its flight plan, so long as the flight plan passes through at least one base station coverage area at any point during its flight.

In one or more examples, each base station 104a-c can be communicatively coupled to a base station controller 106a-c respectively. Thus, in one or more examples, base station 104a can be communicatively coupled to base station controller 106a, base station 104b can be communicatively coupled to base station controller 106b, and base station 104c can be communicatively coupled to base station controller 106c. As described in further detail below, each base station controller can be configured to implement an RF-based communications channel between an operator (I.e. pilot) and an aircraft 102 when the aircraft is transiting through the coverage area 108a-c that corresponds to the base station that the controller is configured to operate. In one or more examples, implementing an RF-based communications channel can include modulating signals transmitted by the operator to a RF spectrum frequency assigned to the aircraft 102, applying an appropriate modulation scheme to the transmitted signals, and applying any other physical layer communications protocols such as error correction codes.

In one or more examples, the goal of the aviation communications network 100 can be to provide any given aircraft 102 operating within the network with a continuous and reliable RF spectrum channel throughout the duration of its flight. In one or more examples, providing a continuous and reliable RF spectrum channel to an aircraft can include providing a single RF spectrum channel (i.e., a time/frequency resource block) to an aircraft that it can reliably use throughout the duration of its flight to communicate with the network. In one or more examples, each aircraft in a given airspace can communicate with the network using a dedicated RF spectrum channel (i.e., a frequency range in the RF spectrum that is unique to the aircraft and can be only used by that individual aircraft to transmit and receive communications from the network). In order to facilitate efficient flight operations, in one or more examples, each base station 104a-c coupled to its corresponding base station controller 106a-c can be configured to ensure that each aircraft in its coverage area 108a-c is able to communicate with the network using communications transmitted in the RF spectrum channel assigned to that aircraft.

In one or more examples, each base station 104a-c can include one or more antennas that are mounted to the base station and are configured to transmit signals from one or more operators (i.e., pilots) to one or more airborne radios mounted on the aircraft 102. In one or more examples, and as described in further detail below, the one or more antennas can be implemented as an array of computer-controlled antennas that can be electronically “steered” to point in different directions depending on the location of the aircraft in the network 100. In one or more examples, the antenna can be implemented as a phased array antenna, which allows for a signal to be directed in a particular direction without having to physically move the antennas. By pointing the antenna in the direction of the target (i.e., the airborne radio that will transmit to and receive data from the antenna), the antenna is able to maximize the signal to noise ratio of the communications link between the antenna and the airborne radio thereby ensuring a stable communications link between the network and the airborne radio.

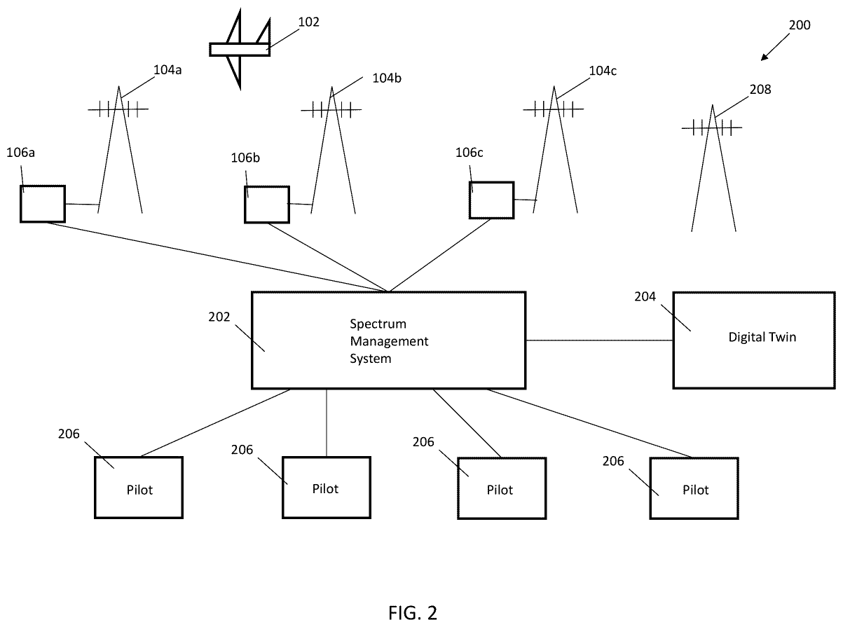

FIG. 2 illustrates an exemplary system for RF spectrum management of aviation communication networks according to examples of the disclosure. In one or more examples of the disclosure, the communications network 200 of FIG. 2 can include the same components (i.e., aircraft 102, base stations 104a-c, and base station controller 106a-c) as the communications network 100 described above with respect to FIG. 1 but can also include one or more spectrum management system components (described in further detail below) that can manage the process of allocating RF spectrum channels to aircraft 102 in the network 200.

In one or more examples of the disclosure, one or more pilots/operators 206 can be connected to the aviation communication network 200 in order to transmit data (such as command and control data) to the one or more aircraft 102. Each of the pilots 206 can be communicatively coupled to the network 200 which utilizes a spectrum management system 202 that can be configured to allocate RF spectrum channels (i.e., in the form of time/frequency resource blocks) to each of the aircraft 102 being controlled by the pilots 206. In one or more examples, the spectrum management system 202 can be configured to facilitate a communications link between each pilot 206 and their corresponding aircraft 102 by establishing an RF communications link using a specified RF spectrum channel (I.e. resource block) allocated to each aircraft.

In one or more examples of the disclosure, the spectrum management system 202 can be configured to manage each active communication link between an aircraft 102 and a pilot/operator 206. Thus, in one or more examples, if the spectrum management system 202 determines that a given communications link has been compromised or has been degraded, the spectrum management system 202 can take action to adjust the communications link to mitigate the issue. For instance, in one or more examples, if a given RF spectrum channel being used by an aircraft 102 is no longer performing satisfactorily or to required specifications, the spectrum management system 202 can change the RF spectrum channel (described in detail below) to an alternative available channel in real-time to ensure that each aircraft maintains a reliable RF communications link. In one or more examples, if the pilot deviates from their advertised flight plan (for example by flying longer than anticipated) the spectrum management system 202 can be configured to take action (for instance by switching the RF channel) to ensure that any interruptions to the communications channel are mitigated.

In one or more examples of the disclosure, in addition to actively managing communication channels, the spectrum management system 202 can be configured to allocate and reserve one or more RF channels for a given flight to be used during the duration of the flight. As described in further detail below, the spectrum management system 202 can receive a flight plan and based on the filed flight plan (as well as other factors such as the availability of the base station transmitter) can allocate an RF channel to each flight in a deterministic manner that takes into account potential interference that may be encountered during the flight.

### Digital Twin

In one or more examples, the spectrum allocation process described above can be implemented exclusively by the spectrum management system 202, and/or can be processed in one or more separate components collectively referred to herein as a “digital twin.” Due to the large volume of information and the potential for spectrum and/or traffic channel requests by tens of thousands of end users (i.e., UAVs) in a given airspace, a digital twin of the spectrum management system can be used to perform the required analysis independently without impacting the operational system performance. In one or more examples, and as illustrated in the example of FIG. 2, the digital twin 204 can be implemented separately from the spectrum management system 202 so as to reduce the processing load of the spectrum management system 202, thus leaving it free to perform the real-time operations associated with managing the active communications channels of aircraft transiting the airspace managed by the spectrum management system 202. Alternatively, the digital twin 204 can also be implemented as part of the spectrum management system such that both the real-time management of air communication links, and communication resource planning for a given flight are performed by the same component.

In one or more examples, the digital twin 204 can be configured to receive one or more requests from the pilots 206 for spectrum to use during a given flight plan. The digital twin, using the flight plan provided by the pilot as well as other factors (described below) can determine what RF spectrum channels to allocate to an aircraft when its flight commences. Once requests are confirmed in the digital twin 204, execution and assignment of the communications channel can be performed.

As described above, the spectrum management system 202 and the digital twin 204 can coordinate the RF spectrum needs of multiple aircraft in a given communications network so as to ensure that each individual aircraft can have access to a reliable, low latency and continuous communications channel with the ground network during the entirety of its flight. In one or more examples, the spectrum management system 202 and the digital twin 204 can work in tandem to allocate and reserve RF spectrum channels for individual aircraft, and as described below, can monitor each individual communications link in-flight to ensure that the communications link is operating to its requirement.

Selecting an RF channel to allocate to a given flight can involve analyzing multiple variables to ensure that the selected channel will service the needs of an aircraft throughout the duration of its flight. In one or more examples, the spectrum management system 202 and the digital twin can analyze several variables such as the available spectrum resources, radio link throughput and performance requirements, radio/link performance metrics, location (including elevation), time-period as well as the radio frequency environment to assign a non-contended resource between the pilot and the aircraft. In one or more examples, the variables that influence channel selection can be populated by several internal and external components to the spectrum management system 202 that work together to match an aircraft to one or more RF channels for use during a flight as described below.

In one or more examples, each pilot (i.e., operator) using the aviation communications network can interface with the network before and during their flight via the spectrum management system 202 and the digital twin 204. Before the flight, and as described below, the pilot or a trusted agent can interface with the spectrum management system and digital twin to receive an RF spectrum channel allocation for use during their flight based on their filed flight plan and other variables. Prior to flight, the spectrum management system 202 can provision the allocated RF spectrum channel to the aircraft to establish a continuous communications link and the spectrum management system can monitor the link during the flight to make sure it is performing within specification.

In one or more examples of the disclosure, the network 200 can include one or more base stations that may or may not be connected to the spectrum management system 202. In one or more examples, a service provider who provides and maintains access to the spectrum management system 202 may not provide coverage to every desired geographic location. In one or more examples, in areas where a pilot may want to operate a flight but that does not fall within a coverage area of an existing base station, the service provider can provide the pilot with a temporary or portable base station 208. In one or more examples, the temporary/portable base station may not have a connection with the spectrum management system 202 and thus cannot receive/transmit information to the spectrum management system for the purposes of provisioning RF channels to aircraft. In one or more examples, these non-connected base stations will have operation plans submitted, into the spectrum management system and digital twin to be coordinated and geofenced for interference and coverage.

In one or more examples, the temporary/portable base station 208 can be used to setup point-to-point and multipoint links between the temporary/portable base station 208 and one or more aircrafts radios for flight operation. In one or more examples of the disclosure, the operator of a temporary/portable base station 208 can inform the service provider a “concept of operation” of the base station 208 that describes the number of aircraft, the times they will fly and the spectrum they will use to communicate with the aircraft. While the spectrum management system 202 may not send real-time information to the temporary/portable base station 208, the spectrum management system 202 can use the concept of operation of the temporary/portable base station to update the geofences (described in detail below) of the base stations 106a-c that are connected to the network and can work to ensure that aircraft that are flying within its network 200 do not cause interference with the flight operations of the temporary/portable base station 208. In one or more examples, the spectrum management system 202 can notify the operators of aircraft transiting the network 200 about the physical limitations to their operations caused by the temporary/portable base station 208 and can factor in the operations of the temporary/portable base station 208 when making RF spectrum slot allocations. In this way, while the spectrum management system 202 may not coordinate the operations of the temporary/portable base station 208, it can work to protect its own network (i.e., the base stations that are connected to the spectrum management system) from the operations of the temporary/portable base station's point-to-point operations.

In one or more examples, and as described above, a given aircraft 102 can communicate with a pilot 206 by utilizing a communications link that can be established between the aircraft 102 and one or more of the base stations 104a-c (or temporary base station 208). In one or more examples, which base station 104a-c to use at any particular given moment during a flight by aircraft 102 can be based on a variety of factors including but not limited to the flight plan submitted for the aircraft 102, the geographic location of the aircraft 102, and other operational conditions of the base stations 104a-c such as RF spectrum conditions of the base stations.

In one or more examples, the spectrum management system 202 or a controller of the network 200 (such as base station controllers 106a-c) can be utilized to coordinate handovers between the base stations 104a-104b in the network 200. In one or more examples, a “handover” can refer to a transfer between base stations of a communications link. For instance, in one or more examples, the spectrum management system 202 can implement a communications link for the aircraft 102 using base station 104a because base station 104a is the closest in proximity to the aircraftg 102. Thus, in one or more examples, base station 104a, and particularly through controller 106a receiving commands from spectrum management system 202 can establish and maintain a communications link between aircraft 102 as the base station. However, as the flight progresses and is moving the coverage area of the network, in one or more examples, the spectrum management system 202 may determine that base station 104a is no longer the best station to utilize for the flight 102 and instead may determine that base station 104b is a better alternative for establishing the needed communications link. For instance, the determination that base station 104b is superior to base station 104a can be based on the geographic position of the aircraft at any given time and/or based on RF spectrum conditions of the airspace as described above. The spectrum management system 202 can thus initiate a handover in which the communications link between the flight 102 and the base station 104a is transferred to base station 104b such that base station 104b provides the communications link between the aircraft 102 and the operator such as the pilot 206.

### Cellular Handover Example

The process of handing over a communications link from one base station to another can involve a series of steps to ensure that the aircraft has an uninterrupted communications link with the aviation communications network. Furthermore, a handover can include a series of steps/procedures that are designed to ensure that the communications between the aircraft and the network are secured such that they cannot be accessed by an unauthorized third party. Furthermore, the handovers can be implemented such that a malicious third party cannot take advantage of the handover procedure to spoof an aircraft on the network (i.e., make the network believe that a third-party signal is being transmitted by the aircraft that is being handed over between base stations). To illustrate how communications handover procedures have been implemented, the cellular/mobile phone context can provide an apt example since, much like aircraft, mobile phones are handed over from base station to base station in a cellular network depending on the spectral conditions of the link between a user equipment (UE) device and a base station.

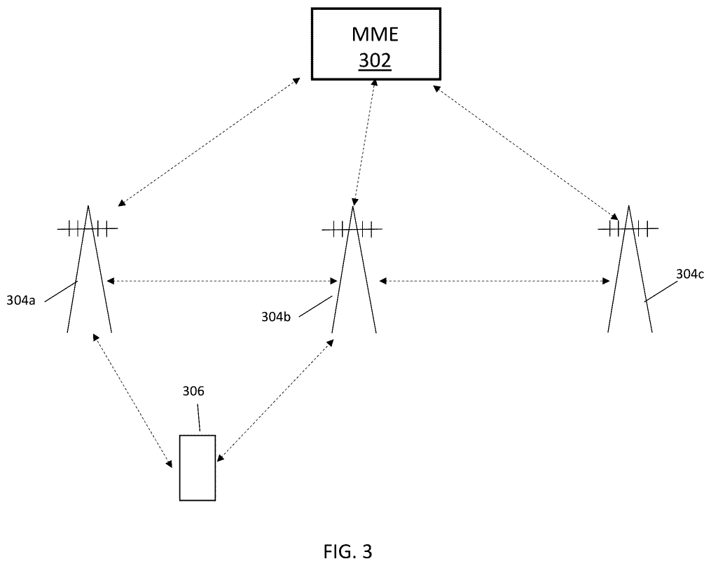

FIG. 3 illustrates an exemplary cellular network according to examples of the disclosure. In one or more examples, the cellular network can be utilized to provide a communications link between a user equipment (UE) 306, and a mobile management entity (MME) 302 which can provide the UE 306 with connectivity to a communications network (not pictured). In one or more examples, and similar to the example of aviation network 200 described above, the cellular network 300 of FIG. 3 can include one or more base stations 304a-c which can be interspersed within a coverage area of the network 300 and can be configured to provide wireless RF communications links between the UE 306 and one or more base stations 304 a-c. In one or more examples, and as described in further detail below, a communications link that is being used to service a particular UE 306 can be handed over between base stations 304a-c as the UE 306 moves within the coverage area of the network 300. Thus, in one or more examples, and as described in further detail below, UE 306 can transmit communications to MME 302 through one or more of the base stations 304a-c depending on the operation conditions of the UE 306 and the spectrum environment that UE 306 encounters.

In one or more examples, the procedure for handing off UE 306 between the base stations 304a-c can involve a procedure/process that not only ensures that the UE 306 maintains an active communications link to the MME 302 (on both the uplink and downlink channels), but also does so in a secure manner. In one or more examples, a secure handover can involve not only ensuring that an unauthorized party does not get access to the communications between UE 306 and the MME 302, but also ensures that if a single base station is compromised by an unauthorized entity, that entity does not subsequently have access to every base station in the network 300.

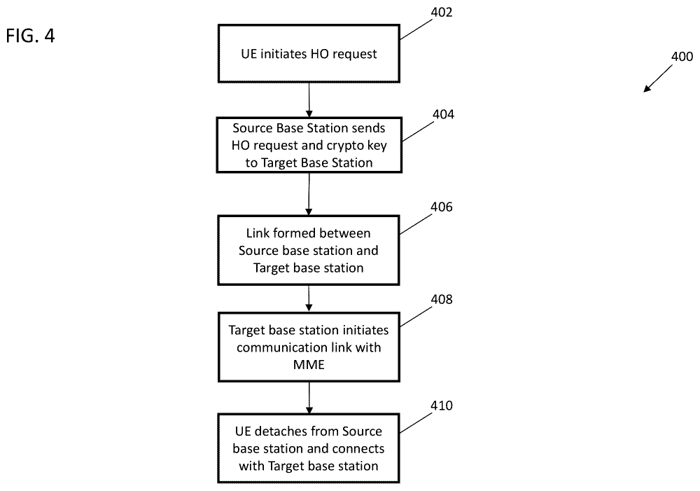

FIG. 4 illustrates an exemplary process for performing handovers in a cellular network according to examples of the disclosure. In one or more examples, the process 400 of FIG. 4 can be used to handover UE communications from one base station to another. In one or more examples, the process 400 of FIG. 4 can begin at step 402 wherein a UE initiates a handover request via the base station it is currently connected to (i.e., a “source” base station.) In one or more examples, the UE can measure the signal strength (or other factors that are indicative of the integrity of the communications channel between the user equipment and the base station) between itself and the source base station. At the same time the UE monitors signal strength of possible target base stations. Once a UE recognizes that an alternative base station in the cellular network (i.e., a “target” base station) is likely to provide a better communications link to it, the device can send a handover request at step 402 to the source base station. In this way, it is the UE that initiates the handover based on an assessment of its own RF environment.

In one or more examples, once the UE transmits the handover request to the source base station at step 402, the process 400 can move to step 404 wherein the source base station transmits the handover request to the target base station. In one or more examples, as part of transmitting the handover request from the source base station to the target base station, the source base station can also transfer one or more cryptographic keys to the target base station that the target base station can use to encrypt the communications between the UE and the MME. In one or more examples, the source base station can generate a cryptographic key to be used by the target base station by hashing the current key it is using with other information concerning the target base station to create a new cryptographic key. In one or more examples, the source base station can use any cryptographic hashing function (such as SHA-256) to generate a cryptographic key for use by the target base station once the handover has been implemented.

In one or more examples, once the source base station has transmitted a handover request as well as the cryptographic keys to the target base station at step 404, the process 400 can move to step 406 wherein the source base station can initiate the formation of a communications data link between the source base station and the target base station that will be specifically tasked with transferring downlink message (i.e., messages transmitted from the MME intended for the user equipment) received at the source base station to the target base station so that the target base station can then transmit those messages to the UE device. In one or more examples, initiating a communication link can refer to transmitting data over a pre-established communication link (physical and/or wired). In one or more examples, the communications link established between the source base station and the target base station can be implemented as an X2 link in accordance with the 3GPP standard for cellular communications.

In one or more examples, once the communications link has been established between the source base station and the target base station, the process 400 can move to step 408 wherein the target base station establishes a communications link with the MME. In one or more the examples, the communications link with the MME can be configured to relay transmissions received from the UE at the target base station to the MME. In one or more examples, while the handover is in progress, messages from the MME intended for the UE are held until the process is complete.

In one or more examples, once the link is established at step 408, the user equipment can then detach or terminate its wireless link with the source base station at step 410. In one or more examples, detaching the UE from the source base station can refer to terminating the wireless link between the source base station and the UE. In one or more examples, the termination of the link can be initiated once the UE has established an uplink and downlink wireless channel with the target base station. As such, the UE is in wireless communications with (1) the source base station, (2) adds the target base station, and (3) terminates the source base station link. As such, the UE is capable of simultaneous communication with two base stations to affect a soft handover. In one or more examples, any subsequent transmissions that are received at the source base station and that are intended for the UE being handed over can be routed from the source base station to the target base station, and the target base station can then relay the communication to the UE via the newly established communications link.

As demonstrated above, the process of handing over communications links between base stations in a cellular communications network can be complex, involving numerous steps and involving the transfer of a large amount of information such as cryptographic keys between base stations. In the cellular network context, the handover process cannot often times cannot be initiated until there is a recognition by the UE (and even in some cases by the cellular network) that a handover is necessary because the source base station may not be the best base station in the network to facilitate wireless communications between the UE and an MME. Thus, in one or more examples, the handover process may have to be initiated and completed in a short time frame since the wireless link being facilitated by the source base station may not perform at an acceptable level all the way through the process of handing over to the target base station. The short notice before performing a handover can thus mean that there is an increased probability that the UE will experience interrupted or dropped communications during the process of handing over the wireless link to the target base station.

In one or more examples, the short amount of time to perform a handover before the wireless link between the UE and the source base station is degraded to an unacceptable level can be attributed to the fact the user equipment moves through the network in a non-deterministic manner. In one or more examples, “non-deterministic” in this context can refer to the fact that the path that the UE will take when moving is not known a priori, and thus determinations as to which base station should facilitate communications between the user equipment and the MME are made “on the fly.” Since the network does not know ahead of time what direction, speed, path, etc., that the mobile user equipment will be travelling in as it traverses the coverage area of the network, handovers cannot be initiated until the network, or the user equipment determines (based on real-time spectral conditions) that a handover is necessary.

### Aviation Communications Network Handover

In the context of a terrestrial cellular network, the fact that the handover between base stations does not begin until a determination is made as to which base station to transfer to based on spectral conditions may be acceptable since the speed at which the UE device may be moving may be slow enough such that the time needed to initiate and complete the handover is acceptable. However, in the context of an aviation communications network, and since an aircraft can move quicker than a mobile device, the time needed to initiate and execute a purely aircraft-initiated handover may not be acceptable or feasible. However, unlike a mobile device moving through the coverage area of a mobile cellular network, an aircraft that is traversing a pre-determined flight path can move through the coverage area of the aviation network in a deterministic manner such that the base station handovers that are needed to service the aircraft may be known far in advance.

In one or more examples, having a priori knowledge of a flight plan can allow for the network to know which base stations will be implicated by the flight path, as well as also know the approximate time when the aircraft will require a handover. Thus, in one or more examples, this knowledge can be utilized to allow for the network to perform at least some of the processes associated with a handover before the actual handover becomes necessary. For instance, and as described above, the transfer of cryptographic keys between the source base station and the target base station can often create latency in the handover process. However, since in the context of the aviation network, an aircraft's flight path can be deterministic (or at least highly probabilistic) and the network can transfer cryptographic keys between source and target base stations prior to initiating the handover procedure rather than doing so during the handover procedure. In this way, the time needed to create and exchange cryptographic keys will not create a delay during the handover process itself, thus minimizing the probability that the aircraft will experience a disturbance or interruption in communications during the flight.

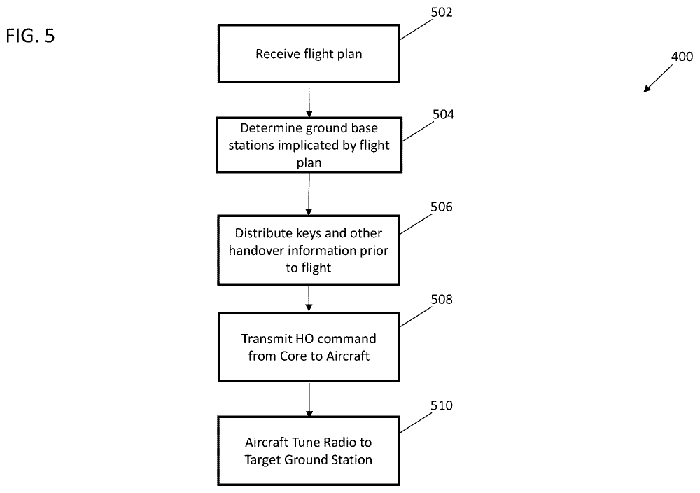

FIG. 5 illustrates an exemplary process for performing handovers in an aviation communication network according to examples of the disclosure. In one or more examples, prior to commencing a planned flight, a flight plan can be submitted for the flight that provides the aviation network with details about the planned flight including but not limited to the intended timing, altitude, location, and speed of the aircraft during a proposed flight. In one or more examples, the flight plan can provide the aviation network (via the spectrum management system for example) with not only the intended route of the flight through the network coverage area, but also the exact timings and speeds at which the proposed flight will be at any given moment during its planned flight. In one or more examples, the flight plan provided to the aviation network can provide the network with a deterministic or at least highly probably path that the flight will take through the aviation network, and thus as described below can be used to facilitate communications handovers in a manner that reduces latency and minimizes the probability that the flight will experience a communications disruption during the communications handover process. Additionally or alternatively, the flight trajectory of an aircraft can be learned or predicted in whole or in part rather than provided. For instance, if a pilot provides the starting location and ending location of a flight, the system may be able to predict the flight trajectory based on prior flights that were taken between the two locations.

In one or more examples, using the flight plan received at step 502 the process 500 at step 504 can determine the base stations of the aviation communications network that will be implicated by the received flight plan. In one or more examples, since the flight plan can provide the aviation communications network with knowledge of what geographic locations the flight will traverse through the network as well as timing information. The aviation network (through the spectrum management system) can determine which base stations will be closest to the aircraft's flight at any given moment during the flight and/or can determine which base stations will be provide the strongest (from a signal-to-noise ratio perspective) communications link with the aircraft at any given moment during the flight. In this way, the aviation network can ascertain, a priori, the handovers that will be needed to service a particular flight based on the received flight plan.

In one or more examples, and to account for potential drift of the aircraft from its intended flight plan, the aviation network can as part of ascertaining the handovers that may be needed to service a particular flight, can also designate base stations that are adjacent or proximal to the base stations implicated as part of the flight as part of the flight path. As described below, in this way, in the event that the flight drifts from its intended course, the infrastructure and processes needed to implement handovers between base stations can still be executed efficiently and without the need for reestablishing cryptographic/encrypted communications between the aircraft and the network.

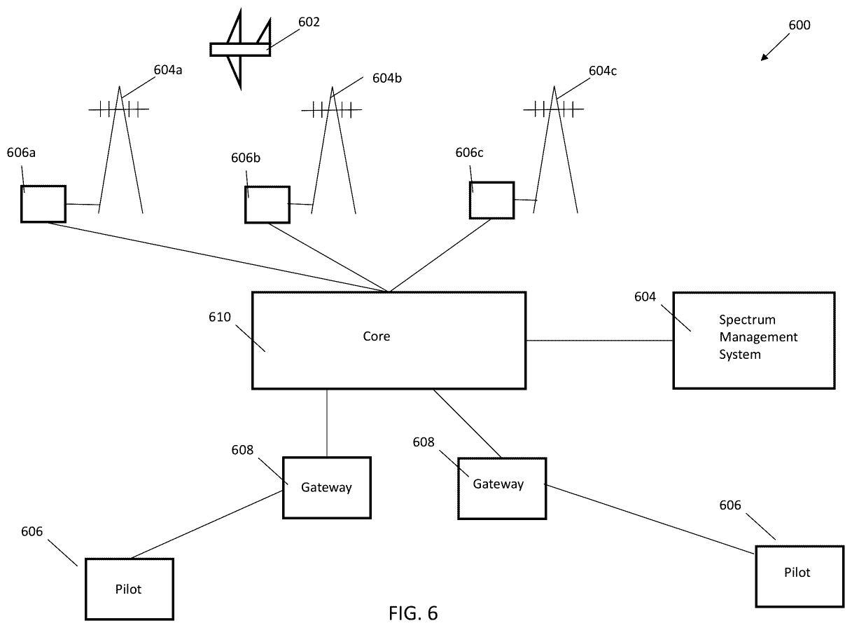

In one or more examples, once the aviation communications network has determined the base stations implicated by a flight plan at step 504, the process 500 can move to step 506 wherein the aviation network can distribute cryptographic keys and other handover information to the implicated base stations prior to the flight requesting a handover. In one or more examples, the base stations can be interconnected to one another via a common computing infrastructure referred to as a “core.” In one or more examples, the core (as discussed in detail below) can, in conjunction with the aircraft that will fly the flight plan, generate and distribute one or more cryptographic keys to each of the base stations implicated by a flight. In one or more examples, the keys generated and distributed to each of the base stations implicated by a flight can be generated and distributed by the core. FIG. 6 illustrates an exemplary aviation communications system according to one or more examples of the disclosure. In one or more examples, the network 600 of FIG. 6 can demonstrate the operation of the core with respect to the network, and specifically with respect to the generation and distribution of cryptographic keys.

In one or more examples, the core 610 of system 600 can include the computing resources associated with maintaining the system 600 and in particular with coordinating the communications between the pilots 606 and the aircraft 602 that they pilot. In one or more examples, the core 610 can also include or communicate with the spectrum management system 604. The spectrum management system 604 operates in substantially the same manner as the spectrum management system described above with respect to FIG. 2. In one or more examples, the core 610 facilitates communications between each pilot 606 and aircraft 602 by receiving and routing communications from the pilots 606 to each aircraft 602 via one or more base stations 604a-c. In one or more examples, each aircraft while in transit can maintain one or more communication links with the core 610 via one or more base stations 604a-c that are connected to the core 610 via their respective base station controllers 606a-c. In one or more examples, the pilots 606, can communicate with the core 610 via one or more gateways 608 that facilitate communications between the core and the pilot. Thus, in one or more examples, the core 610 having communications links to both the pilots 606 and the aircraft 602 via the base stations 604a-c, can facilitate communications traffic between the pilots and the aircraft.

In one or more examples, the communications between the pilots 606 and the core 610 via a gateway 608 may be secured since the communications link can be implemented using a physical wired connection thus minimizing the possibility of interception or spoofing of communications. In one or more examples, the communications between the core 610 and the base station controllers 606 may also be secured since the communications link can be implemented using a physical wired connection thus minimizing the possibility of interception or spoofing of communications. However, in one or more examples, communications between the core 610 and the aircraft may be vulnerable to malicious actors seeking to intercept communications between the base stations 606a-c and the aircraft 602, since the communications are wireless and thus more easily received by non-participants to the communications (i.e., a malicious actor). Thus, in one or more examples, the communications between the base stations 604a-c and the aircraft 602 can be encrypted using one or more encryption schemes to ensure that only the intended recipient is able to read/decipher messages that are intended for them.

Referring to FIGS. 5 and 6, once the base stations implicated by a flight plan are determined at step 504, the process 500 can move to step 506 wherein one or more cryptographic keys are generated and distributed to each of the base stations implicated by the flight plan received at step 502 as determined at step 506. In one or more examples, the core 610 of the system 600 can coordinate the generation and transfer of keys to both the base stations as well as the aircraft flying the flight plan. In one or more examples, the core can generate both a public key as well as a private key, while the aircraft flying the flight plan can also generate its own public and private key. In one or more examples, the public and private keys for both the core (that will be utilized by each base station implicated by a flight) as well as the aircraft can be generated when the flight initiates radio contact with the core prior to commencing the intended flight plan. In this way, by waiting until the flight is about to commence before generating the keys, the chance that a malicious actor can obtain the key is minimized.

In one or more examples, the core 610 and the aircraft 602 can exchange their public keys and each use its own private key along with the public key of the other party to generate a cryptographic key that can be used to encode and decode messages. In one or more examples, the aircraft and the core can utilize a Diffie-Helman Ephemeral key exchange algorithm to generate the keys that will be used during a flight to encode and decode messages. The Diffie-Helman Ephemeral key exchange algorithm is meant as an example only and should not be seen as limiting to the disclosure. In one or more examples, any symmetric-key cypher or public-key protocol can be utilized to secure message between an aircraft and the one or more base stations. In one or more examples, the core 610 can generate the cryptographic key that will be used to decode and encode messages for a particular flight, and at step 506 distribute the key (along with any other handover information) to each of the base stations implicated by a flight plan as determined at step 504. By generating and distributing the keys prior to commencement of the flight, the amount of bandwidth on the RF channel used for coordinating the encryption and decryption of messages between the aircraft and the network can be minimized thus maximizing the reliability of the RF spectrum resources utilized to facilitate communications between the aircraft and the network. In this way, a system that performs a priori, key exchanges before an aircraft is in transit can minimize the likelihood of a communications link failure during the aircraft's transit by reducing any potential strains on the bandwidth.

Once the keys have been distributed to each of the base stations by the core at step 506, of process 500, the aircraft may begin executing its intended flight plan. Once the flight has commenced, the aircraft can maintain communications with the network via one or more of the base stations assigned to field communications between the network and aircraft. Thus, in one or more examples, after the keys have been distributed at step 506, the process 500 can move to step 508 wherein a hand over command is transmitted from the core to the aircraft via the (source) base station that the aircraft is currently connected to during its flight. As discussed above with respect to process 400 of FIG. 4, in the cellular network context the motion of the UE through the network may not be deterministic, hence the UE itself may be required to determine when to initiate a handover from a source base station to a target base station. However, in the aviation communications network context, since the aviation network has a priori knowledge of the UE's (i.e., the flights) route through the coverage area of the network, in one or more examples, the aviation network (via the core 610) itself can determine when to initiate a handover based on the received flight plan and/or the tracked position of the aircraft within the coverage area of the aviation network. In one or more examples, the aviation network (via the core 610) can determine that a handover between base stations is warranted based on a plurality of data including but not limited to the aircraft's current geographic location, the signal quality of the communications link to the base station that is currently being utilized by the aircraft, the time that the aircraft has been in-flight, etc. In one or more examples, once the core 610 has determined that a handover between base stations is warranted, at step 508, the aviation network can transmit a handover command from the source base station (i.e., the base station currently communicating with the aircraft) to the aircraft, instructing the aircraft to initiate communications with a target base station (i.e., the new base station that will provide the aircraft with a communications link to the network). In one or more examples, the determination can be made based on the flight plan as well as the tracked location of the flight at any given moment in time. Additionally, in one or more examples, the determination of when to initiate a handover from a source base station to a target base station can be based on the RF spectral environment of the flight at the source base station, as well as the RF spectral environment of the target base station.

In one or more examples, once the handover command is transmitted from the core 610, via the source base station, to the aircraft at step 508, the process 500 can move to step 510, wherein the aircraft tunes to the target base station frequency. This accomplishes two actions: (1) the link with the source base station is severed and (2) a communications link is established between the aircraft and the target base station. In one or more examples, since the aircraft radio can communicate at a single frequency at any given time, in order to perform a handover, the aircraft radio performs a “hard” handover in which the radio tunes its radio to a new frequency thus severing the link with the source base station in the process of tuning to the target base station. In contrast to the example of FIG. 4, and particular step 406 of cellular handover process 400, rather than have the aviation network base stations themselves facilitate the handover, the aircraft is directed to tune its radio to the target base station. Thus, the single-frequency aircraft radio is used to affect a hard handover Furthermore, in contrast to cellular handover process 400, rather than having to transmit cryptographic keys between the source and target base stations, the aviation handover process 500 can proceed directly to establishing a communication link between the source and target base stations, since the cryptographic keys were exchanged prior to the initialization of the handover based on the received flight plan. In this way, the time from when a handover is initiated to when it is completed can be reduced owing to the fact that any information such as cryptographic keys have already been transmitted to the target base station. In one or more examples, the communications link between the source base station and the target base station can be implemented as an X2 link per the 3GPP standard.

In one or more examples, process 500 may include an element of hysteresis. If at step 510 the aircraft is unable to establish a communications link with the target base station, then in one or more examples, the aircraft has a short period of time to attempt to reestablish a communications link with the source base station so as to maintain continuity in communications with the network. Additionally or alternatively, the network directed handover can be to a backup site rather than to the expected target site in the event that a handover cannot be performed to the target base station.

### Distributed Ledger Flight Record

During operation of the flight, the network elements implicated by a particular flight plan will transmit communications back and forth between an aircraft and a control system operator (I.e. a pilot). For regulatory and safety purposes, recording these transmissions can be required. Given the sensitive nature of the communications between a pilot and an airborne asset, the security of a communications link (established according to a flight plan by the digital twin) should be impervious to outside threats and be able to provide a legal chain of custody so as to preserve the integrity of the recording of data transmitted between elements in the communications network. In some examples, a legal chain of custody provides a chronological documentation of the control, analysis, and/or data transmission history in an aviation communications network. In other words, when recording transmissions occurring across an established network for a particular flight, each transmission should be verified and then recorded only if the transmission is determined to be legitimate. In one or more examples, a transmission is determined to be legitimate by an access-control list (ACL). In one or more examples, a transmission is legitimate if it is sent from a control system to an aircraft and/or it is sent from an aircraft to a control system. In this way, a record of a particular flight's data transmission can be created while minimizing the risk that the recording includes unauthorized or inaccurate data that would otherwise corrupt the record.

An alternative method to maintain a record of a flight is to verify the authenticity of data or transactions (i.e., transmissions of data between network elements) utilizing distributed ledger technology. Distributed ledgers operate as a decentralized database wherein each node of the ledger can independently update data stored on the ledger in a secure manner by only allowing updates to the ledger if there is consensus across nodes of the ledger. As described in further detail below, a distributed ledger can be employed in a flight-plan based communications network to create an immutable record of the flight that can comply with the security requirements of various regulatory agencies.

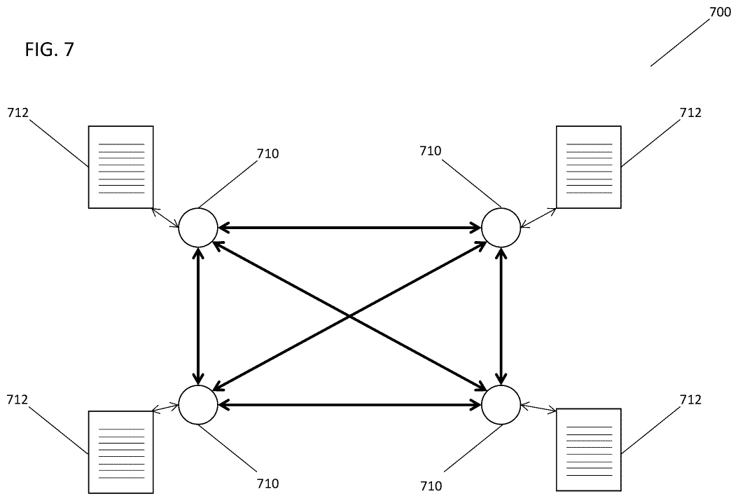

FIG. 7 illustrates an exemplary distributed ledger system according to examples of the disclosure. In one or more examples, distributed ledger 700 may include one or more distributed ledger nodes 710. The distributed ledger nodes 710 may be distributed in a decentralized form across one or more peoples, institutions, locations, and/or processors. In one or more examples, each node 710 of the distributed ledger 700 can include and maintain a ledger 712 that records data. Each distributed ledger node 710 follows the same protocol to maintain and update its associated ledger 712. For example, when distributed ledger 700 receives new data, the new data is sent to each distributed ledger node 710. Once an individual distributed ledger node 710 receives the new data, it may append this new data to the existing data stored in ledger 712 to form an input data, apply a cryptographic hash function to the input data to generate a hashed output, and store the hashed output to its associated ledger 712. By producing the hashed output using the existing data stored in ledger 712, distributed ledger 700 is able to create a sequential chain of cryptographic hash-linked data that act as a secure and immutable record of the historical ledger information.

Distributed ledger 700 is able to provide further security and verifiability by having each distributed ledger node 710 maintain its ledger 712 independently and then verifying that all distributed ledger nodes 710 result in the same ledger 712. In particular, distributed ledger 700 may be configured such that one or more of the distributed ledger nodes 710 may participate in a consensus with one or more other distributed ledger nodes 710 such that each distributed ledger node 710 in consensus uses the same protocol (e.g., same cryptographic hash function) to maintain and update its associated ledger 712. The distributed ledger nodes 710 that participate in a consensus may exchange ledger information to verify that each distributed ledger node 710 in consensus has the same data stored in its associated ledger 712. In one or more examples, distributed ledger 700 may use Byzantine Fault Tolerance (BFT) to achieve consensus. By having distributed ledger nodes 710 independently record and maintain ledger 712, distributed ledger 700 reduces the risk that an error or centralized attack may pose on the integrity of the data recorded in ledger 712. Distributed ledger 700 may generate a single data record by collecting ledger data from each ledger 712 and using the data that the greatest number of ledgers 712 agree on in the data record.

The configuration of distributed ledger 700 allows a system that employs distributed ledger 700 to be able to record data in a secure and immutable manner. Distributed ledger 700 could be employed in an aviation communication network to generate a record of communications between airborne assets and the network such that the record meets reliability, integrity and availability performance targets set forth by regulators. By employing distributed ledger 700 in an aviation communication network, the communication link between airborne assets and the network could be more secure to outside threats and can create an immutable record of the communications to be accessed and used by third parties due to regulatory or technical requirements.

### Aviation Communication Network Example (Implementation?)

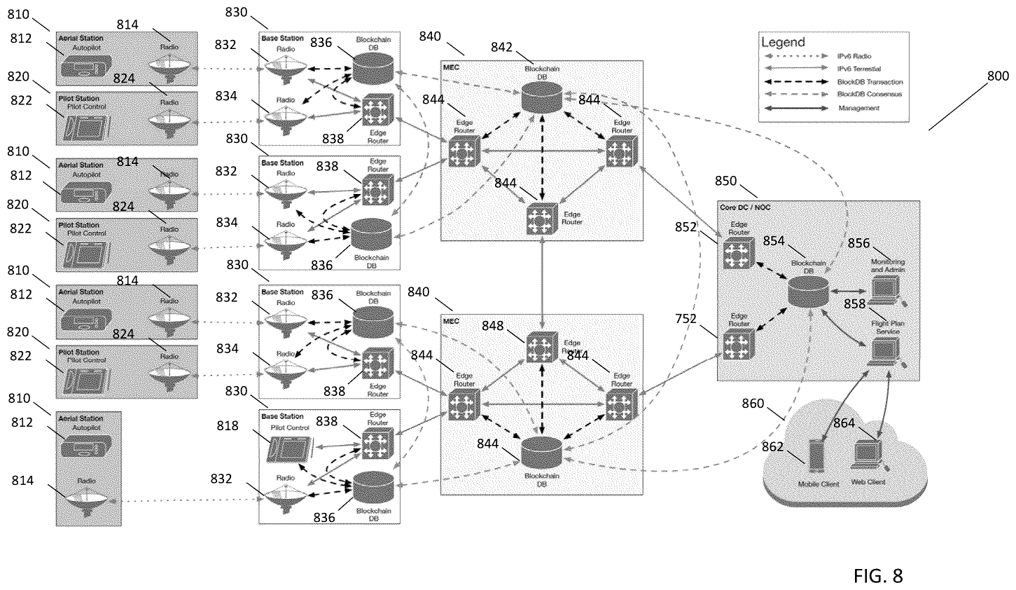

FIG. 8 illustrates an exemplary aviation communication network with distributed ledger capabilities according to examples of the disclosure. In one or more examples, aviation communication network 800 may include one or more aerial stations 810. Aerial station 810 may include autopilot 812 and radio 814. In one or more examples, aerial station 810 may be located on an aircraft, such as aircraft 102 illustrated in FIG. 1. In one or more examples, the autopilot 812 can be configured to command and control an aircraft 102 based on transmissions received at the radio 814. The transmissions can be relayed to radio 814 from a pilot, who provides commands to aerial station 810 via a communications network as described above with respect to FIGS. 1-2. In one or more examples, aviation communication network 800 may include one or more pilot stations 820. Pilot station 820 may include pilot control 822 and radio 824 (radio 824 is optional, specifically in the event that the pilot is connected via a wired connection to the core). Pilot station 820 may be used by pilots/operators 206 on the ground. In one or more examples, pilots/operators 206 may view flight information based on transmissions from aerial station 810 received at radio 824. In one or more examples, pilots/operators 206 may provide commands to aerial station 810 via a communications network as described above with respect to FIGS. 1-2.

In one or more examples, aviation communication network 800 may include one or more base stations 830. Base station 839 may be configured to transmit communications between the core network and the airborne assets. In one or more examples, base station 830 may include a radio 832 and a radio 834. In one or more examples, radio 832 may exchange telemetry packets with radio 814 of aerial station 810. In one or more examples, the packet exchange between radio 832 and radio 814 may use Internet Protocol version 6 (IPv6) as a protocol to format the transmission of the data. In one or more examples, radio 834 may exchange telemetry packets with radio 824 of pilot station 820. In one or more examples, the packet exchange between radio 832 and radio 814 may use IPv6 as a protocol to format the transmission of the data. In one or more examples, telemetry packets may be generated by an aircraft such as aircraft 102 from FIG. 1. In one or more examples, telemetry packets may be generated by a pilot such as a pilot 206 from FIG. 2. In one or more examples, telemetry packets may be generated by and transmitted between edge routers such as edge routers 838, 844, and 852.

In one or more examples, base station 830 may include edge router 838 to transmit communications between the network and the airborne assets. Radio 832 and radio 834 may exchange telemetry packets with edge router 838. In one or more examples, the telemetry packets communicated by radio 832 may include flight information from aerial station 810. In one or more examples, the telemetry packets communicated to radio 834 may include command information provided by pilots/operators 206. The packet exchange between radio 832, radio 834, and edge router 838 may use IPv6 as a protocol to format the transmission of the data.

In one or more examples, base station 830 may be configured to act as a distributed ledger node by including a base station database 836 to store ledger information. In one or more examples, radio 832, radio 834, and edge router 838 may communicate data packets with base station database 836. In one or more examples, the data packets communicated with base station database 836 may be used to update ledger data stored at the base station database 836. In response to receiving data packets, base station database 836 may update its ledger data by appending the new data packet to the existing ledger data to generate an input data, applying a cryptographic hash function to the input data to generate a hashed output, and storing this hashed output to base station database 836 as an updated ledger information. In one or more examples, the one or more base station databases 836 may be in consensus such that the same ledger data is stored at each base station database 836.

In one or more examples, base station 830 may include pilot control 818. Pilot control 818 may exchange telemetry packets with edge router 838. The packet exchange between pilot control 818 and edge router 838 may use IPv6 as a protocol to format the transmission of the data. In one or more examples, pilot control 818 may communicate data with base station database 836. In one or more examples, the data communicated between pilot control 818 and base station database 836 may be used to construct ledger data at the base station database 836.

In one or more examples, aviation communication network 800 may include one or more Multi-access Edge Computing (MEC) system 840 with one or more edge routers 844. Edge routers 844 may exchange data packets with each other, wherein the data packets contain communications between airborne assets and the network. In one or more examples, packet exchange between edge routers 844 use IPv6 as a protocol to format the transmission of the data. In one or more examples, at least one edge router 844 of MEC system 840 may transmit telemetry packets with edge router 838 of base station 830.

In one or more examples, MEC system 840 may be configured to act as a distributed ledger node by including MEC database 842 to store ledger information. In one or more examples, edge routers 844 may communicate data packets with MEC database 842. In one or more examples, the data packets communicated with MEC database 842 may be used to update ledger data stored at the MEC database 842. In response to receiving data packets, MEC database 842 may update its ledger data by appending the new data packet to the existing ledger data to generate an input data, applying a cryptographic hash function to the input data to generate a hashed output, and storing this hashed output to MEC database 842 as an updated ledger information. In one or more examples, MEC database 842 is in consensus with base station database 836 such that ledger data stored at MEC database 842 is in agreement with ledger data stored at base station database 836. In one or more examples, one or more MEC databases 842 are in consensus such that ledger data stored at MEC databases 842 may be in agreement.

In one or more examples, aviation communication network 800 may include core Data Center (DC) 850. In one or more examples, core DC 850 may include one or more edge routers 852 that exchange data packets with edge router 844 of MEC system 840. The data packets transmitted to and from edge routers 852 may include communications between airborne assets and the network. In one or more examples, packet exchange between edge router 844 of MEC system 840 and edge router 852 of core DC 850 may use IPv6 as a protocol to format the transmission of the data.

In one or more examples, core DC 850 may be configured to act as a distributed ledger node by including a core DC database 854. In one or more examples, edge routers 852 may communicate data packets with core DC database 854. In one or more examples, the data communicated may be used to construct ledger data at core DC database 854. In one or more examples, the data packets communicated between edge routers 852 and core DC database 854 may be used to update ledger data stored at the core DC database 854. In response to receiving data packets, core DC database 854 may update its ledger data by appending the new data packet to the existing ledger data to generate an input data, applying a cryptographic hash function to the input data to generate a hashed output, and storing this hashed output to core DC database 854 as an updated ledger information. In one or more examples, core DC database 854 can be in consensus with MEC database 842 such that ledger data stored at core DC database 854 is in agreement with ledger data stored at MEC database 842. In one or more examples, core DC database 854 can be in consensus with base station database 836 such that ledger data stored at core DC database 854 is in agreement with ledger data stored at base station database 836.

In one or more examples, core DC 850 may include monitoring and administration station 856. Monitoring and administration station 856 may include one or more processors. In one or more examples, monitoring and administration station 856 may provide an interface to the spectrum management system 202 to support access control policy for planned, active and completed flight information. Monitoring and administration station 856 may also manage access to specifically predefined data that is transmitted or stored in the aviation communication network 800. For example, monitoring and administration station 856 may utilize filtering techniques to allow internal and external services to access information that enable and support the flight mission. In one or more examples, monitoring and administration station 856 may provide a performance reporting function on the data integrity after the completion of a flight.

In one or more examples, core DC 850 may include flight plan service 858. In one or more examples, flight plan service 858 may include one or more processors. In one or more examples, flight plan service 858 may receive flight plan information.

In one or more examples, aviation communication network 800 includes user interface 860 to receive flight plan information from an authorized user and/or to transmit flight plan information to flight plan service 858. In one or more examples, user interface 860 may include a mobile client 862 that runs on mobile devices. In one or more examples, user interface 864 may include web client 864 that runs on internet-enabled devices.

In one or more examples, flight plan service 858 may relate flight plan information to one or more network elements in the aviation communication network 800. By relating the flight plan information to one or more networks elements, the aviation communication network 800 may be initialized by flight plan basis. In particular, the identified network elements may be initialized as distributed ledger nodes with ledger information stored at each distributed ledger node in an associated database. In one or more examples, flight plan service 858 may communicate the flight plan information to the one or more network elements identified with the flight plan, and the network elements initialize the associated ledger information with the flight plan information.

In one or more examples, the distributed ledger system described above uses a received flight plan to determine the elements of the network including the base stations that are implicated by a received flight plan. Similarly, as described above, handover information including cryptographic keys can be distributed, a priori, to base stations implicated by a given flight plan. Since both processes (i.e., creation of a distributed ledger as well as handover information distribution) use a flight plan in similar manners, in one or more examples, the creation of the distributed ledger, and the distribution of handover information can be combined into a single integrated process.

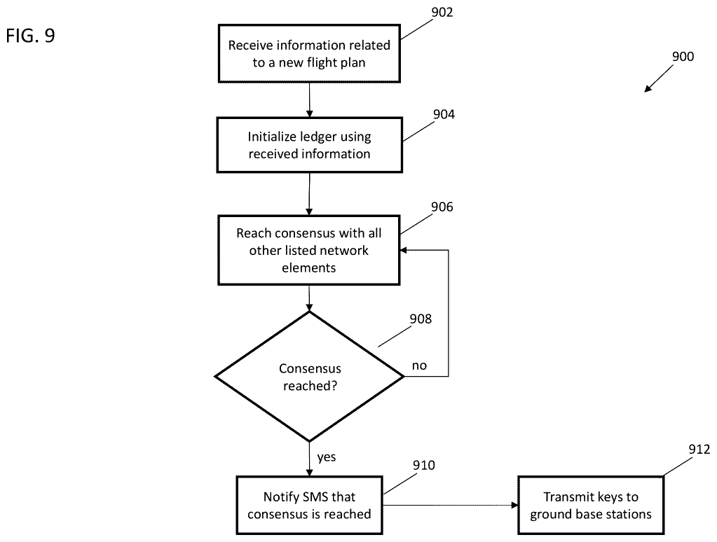

FIG. 9 illustrates an exemplary process for performing handovers in an aviation communications network with distributed ledger capabilities according to examples of the disclosure. In one or more examples, the process 900 of FIG. 9 can begin at step 902 wherein flight plan information may be received. Once the aviation communication network receives the flight plan information, the aviation network (for instance via the spectrum management system or other controller) may relate the flight plan information to identify and initialize one or more network elements in aviation communication system that are implicated in the flight plan. In one or more examples, step 902 can further include a network element of aviation communication system that is implicated by the flight information receiving information related to the new flight plan information. The flight plan information received by a network element may include time, flight route, durations, speeds, elevations, locations, airframe type, radio and antenna configuration and/or data throughput information. In one or more examples, the flight information received in step 902 may include one or more network elements in aviation communication system that are related to the flight plan. In one or more examples, the flight information received in step 602 may include one or more network elements in aviation communication system that are in consensus.

In one or more examples of the disclosure, a spectrum management system such as the one described above with respect to FIG. 4 in conjunction with the core described above with respect to FIG. 6, can be used to identify one or more network elements for a given flight plan. When an operator submits a flight plan to the spectrum management system and/or the digital twin (as described above), the spectrum management system can plan the flight (from a communications link perspective) so as to ensure that the flight is provided with a reliable communications link throughout the duration of the flight. Once a communications link plan has been established, the network elements implicated by that link plan can be associated with the flight plan. Thus, at step 902, the flight plan can include an identification of the network elements associated with the flight plan as determined by the spectrum management system.

After receiving a flight plan with an identification of network elements at step 902, the process 900 can move to step 904 wherein a ledger stored in a database at the network element can initialized with the flight information received in step 902. In one or more examples, the network element may initialize ledger information by applying a cryptographic hash function to the flight information and storing the output of the cryptographic hash function in a memory. In one or more examples, the ledger includes information of the network elements in aviation communication system identified by the flight information received in step 902. In one or more examples, the ledger information identifies one or more network elements in aviation communication system that participate in a consensus.

After initializing the ledger at step 904, the process 900 can move to step 906, wherein the network elements identified as participating in a consensus may perform a consensus process to ensure that the ledger information at all distributed ledger nodes is the same. In one or more examples, the consensus algorithm may involve the network element sending its ledger information to other network elements participating in the consensus. In one or more examples, the consensus algorithm may involve the network element receiving ledger information from other network elements participating in the consensus. The network element may then compare the ledger information received from the other network elements with each other and with the ledger information associated with the network element. In or more examples, the network element may update the associated ledger information such that the ledger information is in agreement with a majority of the received ledger information from other network elements participating in a consensus. In one or more elements, the updated ledger information is linked to the historical ledger information through keys and/or cryptographic signatures.

In step 908, process 900 can determine if a consensus is reached. If a consensus is not reached, there may have been an error in the transmission of the data packets or in the initialization process. In one or more examples, if it is determined that consensus is not achieved, the aviation network can be notified that an error has occurred. In one or more examples, if it is determined that consensus is not achieved, steps 906 and 908 are repeated until consensus is reached and all network elements participating in the consensus have the same ledger information.

### Key Transfer Prior to Handover

If in step 908, it is determined that consensus has been reached, process 900 continues to step 910. In step 910, the network element may notify the spectrum management system that consensus has been achieved. In one or more examples, once consensus has been reached at step 910, the process 900 can move to step 912 wherein the aviation communications network (through the spectrum management system or one or more other controllers in the network) transmits the cryptographic keys and other handover information to each of the base stations prior to commencement of the flight or at least prior to any particular handover between base stations being initiated. In one or more examples, step 912 of process 900 can be substantially similar to step 506 of process 500 described above.

As described above, the handover process can be made more efficient and network-driven due in part to the deterministic nature of a flight embodied by the flight plan that is submitted to the aviation communications network prior to commencement of the flight. However, often times, a flight may be required to deviate from its intended flight due to air traffic control requirements, weather, etc. In such an instance, the deviation may implicate new base stations that were not originally part of the set of base stations that were implicated by the original flight plan. Thus, in one or more examples, it may become necessary during the course of the flight for the aviation network (and in particular one or more controllers or the spectrum management system) to modify the flight plan to account for any required deviations. In one or more examples, such deviations may require not only a modification to the distributed ledger to account for any newly implicated communication elements of the modified flight plan but may also require that additional base stations receive handover information to account for the new flight plan.

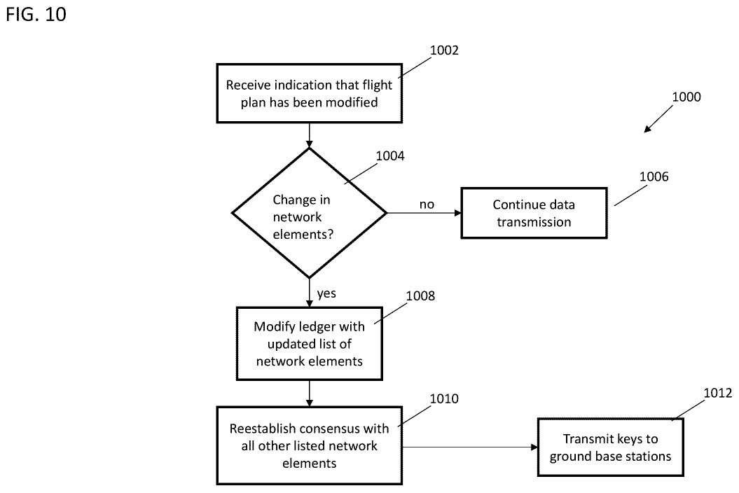

FIG. 10 illustrates an exemplary process for performing handovers in an aviation communications network with distributed ledger capabilities when a deviation in a flight plan occurs according to examples of the disclosure. In one or more examples, the process 1000 of FIG. 10 can begin at step 1002 wherein a network element may receive an indication that there has been a deviation by the aircraft such that the flight plan has been modified.

In one or more examples, after receiving the indication of a deviation at step 1002, the process 1000 can move to 1004 wherein the spectrum management system or other processing entity that administers the distributed ledger can determine if the network elements associated with this modified flight plan differ from network elements associated with the original flight plan. In one or more examples, an authorized user may input information related to a change in network elements and transmit this information to the network elements currently associated with aviation communication network.

If in step 1004, it is determined that the modified flight plan does not change the network elements associated with aviation communication system (e.g., the modified flight plan does not involve adding new network elements to the aviation communication system or removing existing network elements from the current aviation communication system), the process 1000 proceeds to step 1006 and continues data transmission as described above.

If in step 1004 it is determined that the modified flight plan modifies the network elements associated with aviation communication system, the process 1000 can proceed to step 1008 wherein the list of network elements identified with the modified flight plan are updated.

As part of the process of modifying the nodes on the distributed ledger, at step 1008, the aviation communications network establishes an updated distributed ledger with distributed ledger nodes based on the modified list of network elements. The aviation communications network with the updated distributed ledger reestablishes consensus with the other network elements of the updated distributed ledger system. In some examples, a network element can send its associated ledger information to other network elements participating in consensus in the updated distributed ledger, receive ledger information from other network elements participating in consensus in the updated distributed ledger, and performs the consensus process as described above. In some examples, the consensus process includes transmitting the data previously recorded at each node of the distributed ledger system associated with the originally received flight plan. Thus, in one or more examples, once the ledger has been modified at step 1008, the process 1000 can move to step 1010 wherein consensus is reestablished between all of the network elements (including the newly added elements).

In one or more examples, once consensus has been established at step 1010, the process can move to step 1012 wherein any handover information including cryptographic keys are transmitted to any new network elements that are implicated by the deviation of the flight plan. In one or more examples, the identification of newly implicated network elements can be made as part of the process for modifying the distributed ledger and thus transmitting handover information to newly implicated network elements can be integrated with the process for modifying the distributed ledger associated with a particular flight plan. The examples described above with respect to the distributed ledger are optional and should not be seen as limiting to the disclosure. The handover process can be performed outside of the context of implementing a distributed ledger as described above, and thus a distributed ledger is not required in order to implement the handover processes described above.

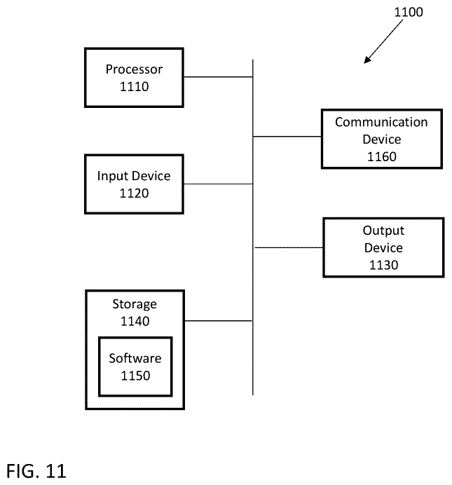

FIG. 11 illustrates an exemplary computing system, according to examples of the disclosure. FIG. 11 illustrates an example of a computing system 1100, in accordance with some embodiments system 1100 can be a client or a server. As shown in FIG. 11, system 1100 can be any suitable type of processor-based system, such as a personal computer, workstation, server, handheld computing device (portable electronic device) such as a phone or tablet, or dedicated device. The system 1100 can include, for example, one or more input devices 1120, output devices 1130, one or more processors 1110, storage 1140, and communication devices 1160. Input device 1120 and output device 1130 can generally correspond to those described above and can either be connectable or integrated with the computer.

Input device 1120 can be any suitable device that provides input, such as a touch screen, keyboard or keypad, mouse, gesture recognition component of a virtual/augmented reality system, or voice-recognition device. Output device 1130 can be or include any suitable device that provides output, such as a display, touch screen, haptics device, virtual/augmented reality display, or speaker.

Storage 1140 can be any suitable device that provides storage, such as an electrical, magnetic, or optical memory including a RAM, cache, hard drive, solid-state drive (SSD), removable storage disk, or other non-transitory computer readable medium. Communication device 1160 can include any suitable device capable of transmitting and receiving signals over a network, such as a USB or WiFi or Ethernet network interface chip or device. The components of the computing system 1100 can be connected in any suitable manner, such as via a physical bus or wirelessly.

Processor(s) 1110 can be any suitable processor or combination of processors, including any of, or any combination of, a central processing unit (CPU), field programmable gate array (FPGA), and application-specific integrated circuit (ASIC). Software 1150, which can be stored in storage 1140 and executed by one or more processors 1110, can include, for example, the programming that embodies the functionality or portions of the functionality of the present disclosure (e.g., as embodied in the devices as described above)

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to the cloud, an electronic, magnetic, optical, electromagnetic, or infrared wired or wireless propagation medium.

System 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections (Bluetooth, WiFi, cellular), T1 or T3 lines, cable networks, DSL, or telephone lines.

System 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for performing communications handovers between communication elements in an aviation communications network, the method comprising:
receiving a flight plan, wherein the received flight plan comprises timing, location, and altitude information for an aircraft that is to fly in one or more coverage areas of the aviation communications network;
determining one or more communication elements of the aviation communications network associated with the received flight plan;
generating handover information for each of the one or more communication elements of the aviation communications network;
transmitting the handover information to the communication elements of the one or more communication elements associated with the handover information;
determining that a communications handover from a source communications element to a target communications element is required, wherein the determination occurs after the handover information to the one or more communication elements has been transmitted; and
transferring a communications link between the source communications element and the aircraft from the source communications element to the target communications element in response to the determination that the communications handover from a source communications element to a target communications element is required during the flight.

2. The method of claim 1, wherein the one or more communications elements comprises one or more base stations of the aviation network, and wherein each base station of the aviation network is configured to transmit RF communications between an operator and the aircraft.

3. The method of claim 2, wherein determining one or more communication elements of the aviation communications network associated with the received flight plan comprises determining which base stations will be closest to the aircraft at any given moment while the aircraft is flying the received flight plan.

4. The method of claim 1, wherein generating handover information for each of the one or more communication elements of the aviation communications network comprises generating one or more cryptographic keys for each of the one or more communication elements, and wherein the one or more cryptographic keys are configured to encrypt communications between the aircraft and the one or more communications elements.

5. The method of claim 1, wherein generating one or more cryptographic keys for each of the one or more communication elements comprises performing a Diffie-Helman Ephemeral algorithm to generate the cryptographic keys.

6. The method of claim 1, wherein transmitting the handover information to the communication elements of the one or more communication elements associated with the handover information occurs prior to the aircraft beginning a flight associated with the received flight plan.

7. The method of claim 1, wherein the method comprises initiating a distributed ledger system on the one or more communication elements determined to be associated with flight plan, wherein the distributed ledger comprises one or more nodes, and wherein each communication element of the one or more communication elements determined to be associated with the flight plan is configured to operate as a node in the distributed ledger system.

8. The method of claim 7, wherein initiating a distributed ledger system on the one or more communication elements determined to be associated with flight plan comprises:
applying a consensus process to the one or more communications element determined to be associated with the flight.

9. The method of claim 8, wherein the handover information is transmitted to the communication elements of the one or more communication elements associated with the handover information after the consensus process has been completed.

10. The method of claim 7, wherein the method comprises:
receiving an indication that the received flight plan has been modified;
determining whether the one or more communication elements of the aviation communications network associated with the received flight plan has changed based on the received indication that the flight plan has been modified; and
modifying the distributed ledger system to include one or more new communications elements associated with the changed flight plan.

11. The method of claim 10, wherein method comprises:
generating handover information for each of the one or more new communications elements associated with changed flight plan; and
transmitting the handover information to the one or more new communications elements associated with changed flight plan.

12. The method of claim 11, wherein the method comprises applying a consensus process to the modified distributed ledger system.

13. The method of claim 12, wherein transmitting the handover information to the one or more new communications elements associated with changed flight plan occurs after the consensus process has been applied to the modified distributed ledger system.

14. A system for performing communications handovers between communication elements in an aviation communications network, the system comprising:
a memory;
one or more processors;
wherein the memory stores one or more programs that when executed by the one or more processors, cause the one or more processors to:
receive a flight plan, wherein the received flight plan comprises timing, location, and altitude information for an aircraft that is to fly in one or more coverage areas of the aviation communications network;
determine one or more communication elements of the aviation communications network associated with the received flight plan;
generate handover information for each of the one or more communication elements of the aviation communications network;
transmit the handover information to the communication elements of the one or more communication elements associated with the handover information;
determine that a communications handover from a source communications element to a target communications element is required, wherein the determination occurs after the handover information to the one or more communication elements has been transmitted; and
transfer a communications link between the source communications element and the aircraft from the source communications element to the target communications element in response to the determination that the communications handover from a source communications element to a target communications element is required during the flight.

15. The system of claim 14, wherein the one or more communications elements comprises one or more base stations of the aviation network, and wherein each base station of the aviation network is configured to transmit RF communications between an operator and the aircraft.

16. The system of claim 15, wherein determining one or more communication elements of the aviation communications network associated with the received flight plan comprises determining which base stations will be closest to the aircraft at any given moment while the aircraft is flying the received flight plan.

17. The system of claim 14, wherein generating handover information for each of the one or more communication elements of the aviation communications network comprises generating one or more cryptographic keys for each of the one or more communication elements, and wherein the one or more cryptographic keys are configured to encrypt communications between the aircraft and the one or more communications elements.

18. The system of claim 14, wherein generating one or more cryptographic keys for each of the one or more communication elements comprises performing a Diffie-Helman Ephemeral algorithm to generate the cryptographic keys.

19. The system of claim 14, wherein transmitting the handover information to the communication elements of the one or more communication elements associated with the handover information occurs before the aircraft occurs prior to the aircraft beginning a flight associated with the received flight plan.

20. The system of claim 14, wherein the one or more processors are further caused to initiate a distributed ledger system on the one or more communication elements determined to be associated with flight plan, wherein the distributed ledger comprises one or more nodes, and wherein each communication element of the one or more communication elements determined to be associated with the flight plan is configured to operate as a node in the distributed ledger system.

21. The system of claim 20, wherein initiating a distributed ledger system on the one or more communication elements determined to be associated with flight plan comprises:
applying a consensus process to the one or more communications element determined to be associated with the flight.

22. The system of claim 21, wherein the handover information is transmitted to the communication elements of the one or more communication elements associated with the handover information after the consensus process has been completed.

23. The system of claim 20, wherein the one or more processors are caused to:
receive an indication that the received flight plan has been modified;
determine whether the one or more communication elements of the aviation communications network associated with the received flight plan has changed based on the received indication that the flight plan has been modified; and
modify the distributed ledger system to include one or more new communications elements associated with the changed flight plan.

24. The system of claim 23, wherein the one or more processors are caused to:
generate handover information for each of the one or more new communications elements associated with changed flight plan; and
transmit the handover information to the one or more new communications elements associated with changed flight plan.

25. The system of claim 24, wherein the one or more processors are caused to apply a consensus process to the modified distributed ledger system.

26. The system of claim 25, wherein transmitting the handover information to the one or more new communications elements associated with changed flight plan occurs after the consensus process has been applied to the modified distributed ledger system.

27. A non-transitory computer readable storage medium storing one or more programs performing communications handovers between communication elements in an aviation communications network, for execution by one or more processors of an electronic device that when executed by the device, cause the device to:
receive a flight plan, wherein the received flight plan comprises timing, location, and altitude information for an aircraft that is to fly in one or more coverage areas of the aviation communications network;
determine one or more communication elements of the aviation communications network associated with the received flight plan;
generate handover information for each of the one or more communication elements of the aviation communications network;
transmit the handover information to the communication elements of the one or more communication elements associated with the handover information;
determine that a communications handover from a source communications element to a target communications element is required, wherein the determination occurs after the handover information to the one or more communication elements has been transmitted; and
transfer a communications link between the source communications element and the aircraft from the source communications element to the target communications element in response to the determination that the communications handover from a source communications element to a target communications element is required during the flight.

28. The non-transitory computer readable storage medium of claim 27, wherein the one or more communications elements comprises one or more base stations of the aviation network, and wherein each base station of the aviation network is configured to transmit RF communications between an operator and the aircraft.

29. The non-transitory computer readable storage medium of claim 28, wherein determining one or more communication elements of the aviation communications network associated with the received flight plan comprises determining which base stations will be closest to the aircraft at any given moment while the aircraft is flying the received flight plan.

30. The non-transitory computer readable storage medium of claim 27, wherein generating handover information for each of the one or more communication elements of the aviation communications network comprises generating one or more cryptographic keys for each of the one or more communication elements, and wherein the one or more cryptographic keys are configured to encrypt communications between the aircraft and the one or more communications elements.

31. The non-transitory computer readable storage medium of claim 27, wherein generating one or more cryptographic keys for each of the one or more communication elements comprises performing a Diffie-Helman Ephemeral algorithm to generate the cryptographic keys.

32. The non-transitory computer readable storage medium of claim 27, wherein transmitting the handover information to the communication elements of the one or more communication elements associated with the handover information occurs before the aircraft occurs prior to the aircraft beginning a flight associated with the received flight plan.

33. The non-transitory computer readable storage medium of claim 27, wherein the device is caused to initiate a distributed ledger system on the one or more communication elements determined to be associated with flight plan, wherein the distributed ledger comprises one or more nodes, and wherein each communication element of the one or more communication elements determined to be associated with the flight plan is configured to operate as a node in the distributed ledger system.

34. The non-transitory computer readable storage medium of claim 33, wherein initiating a distributed ledger system on the one or more communication elements determined to be associated with flight plan comprises:
applying a consensus process to the one or more communications element determined to be associated with the flight.

35. The non-transitory computer readable storage medium of claim 34, wherein the handover information is transmitted to the communication elements of the one or more communication elements associated with the handover information after the consensus process has been completed.

36. The non-transitory computer readable storage medium of claim 33, wherein the device is caused to:
receive an indication that the received flight plan has been modified;
determine whether the one or more communication elements of the aviation communications network associated with the received flight plan has changed based on the received indication that the flight plan has been modified; and
modify the distributed ledger system to include one or more new communications elements associated with the changed flight plan.

37. The non-transitory computer readable storage medium of claim 36, wherein the device is caused to:
generate handover information for each of the one or more new communications elements associated with changed flight plan; and
transmit the handover information to the one or more new communications elements associated with changed flight plan.

38. The non-transitory computer readable storage medium of claim 37, wherein the device is caused to apply a consensus process to the modified distributed ledger system.

39. The non-transitory computer readable storage medium of claim 38, wherein transmitting the handover information to the one or more new communications elements associated with changed flight plan occurs after the consensus process has been applied to the modified distributed ledger system.
